(19) United States
(12) Patent Application Publication
(10) Pub. No.: US 2008/0169233 A1
(43) Pub. Date: Jul. 17, 2008

(54) Oil filter assembly

(75) Inventors: Friedhelm Pfitzer, Rangendingen (DE); Peter Jungmann, Bisingen (DE); Stefan Heinz, Bodelshausen (DE); Alexander Maute, Hechingen-Stetten (DE)

Correspondence Address: DREISS, FUHLENDORF, STEIMLE & BECKER, POSTFACH 10 37 62, D-70032 STUTTGART, omitted

(73) Assignee: Joma-Polytec Kunststofftechnik GmbH, Bodelshausen (DE)

(21) Appl. No.: 11/652,111

(22) Filed: Jan. 11, 2007

(51) Int. Cl. B01D 35/30

(52) U.S. Cl. 210/248

(57) ABSTRACT

An oil filter assembly with a housing which comprises a receiving chamber for a filter element can be inserted into the housing and through which oil can flow in a radial direction, and with a housing lid that closes the receiving chamber, wherein a pure oil or unfiltered oil opening that is surrounded by a pipe socket, and a channel chamber extending in the longitudinal direction of the receiving chamber are provided at the bottom of the receiving chamber. A drainage plate is provided in the bottom area of the receiving chamber, which is disposed on the pipe socket such that it can be axially displaced to at least a certain degree and has a closing means, wherein at least one pressure spring is disposed between the drainage plate and the bottom such that in the operating position when the housing is closed and the filter element is inserted, the drainage plate is loaded by the filter element against the spring force and the closing means closes a drainage opening of the channel chamber.

This application is related to EP 05 015 179.4 filed Jul. 13, 2005 the complete disclosure of which is hereby incorporated by reference.

### BACKGROUND OF THE INVENTION

The invention concerns an oil filter assembly with a housing which has a receiving chamber for a filter element that can be inserted into the housing and through which oil can flow in a radial direction, and a housing lid that closes the receiving chamber.

DE 39 03 675 C2 discloses a conventional, similar filter assembly.

JP 2003 320206 discloses an oil filter assembly, wherein a rotor is provided at the bottom of the receiving chamber in order to also rotate the filter element during screwing-in of the housing lid, thereby preventing undesired torsion of the filter element.

DE 102 35 902 A1 discloses disposing a pure oil opening, which is surrounded by a pipe socket, at the bottom of the receiving chamber. In addition, an outlet opening is provided at the bottom which can be closed via a closing piece which is provided on a spring buckle. When the filter element is inserted, the closing piece is moved into the closed position via the spring buckle. When the filter element is removed, the outlet opening is opened due to the resilience of the spring buckle. Provision of an outlet channel is advantageous in that oil that is present in the receiving chamber can be discharged prior to complete removal of the filter element. This facilitates handling and changing of the filter element.

It is the underlying purpose of the present invention to further develop these conventional devices and, in particular, increase the functional and operational reliability of the oil filter assembly.

### SUMMARY OF THE INVENTION

Towards this end, in accordance with the invention, a drainage plate with closing means is disposed in the bottom area of the receiving chamber which can be axially displaced at least to a limited degree, wherein at least one pressure spring is disposed between the drainage plate and the bottom such that, in the operating position with closed housing and inserted filter element, the drainage plate is loaded by the filter element against the spring force, and the closing means closes a drainage opening of the channel chamber. The invention provides a drainage plate which is displaceably disposed on the pipe socket, and also a pressure spring which loads the drainage plate. The drainage plate thereby has a central opening into which the pipe socket engages. In the operating position, the filter element acts against the drainage plate, whereby the closing means closes the drainage opening. The drainage plate, including closing means, may thereby be produced from a relatively inflexible material which provides large forces for closing the drainage opening. In accordance with prior art of DE 102 35 902 A1, the closing force depends on the elasticity of the spring buckle, since the spring buckle is loaded by the filter element to close the outlet channel.

In accordance with the invention, the drainage plate is advantageously pressed from the operating position into an outlet position in which the drainage opening is open, when the housing lid of the pressure spring is opened. The drainage opening is thereby automatically opened when the filter element is removed. With particular preference, the pressure spring is designed such that when the housing lid is opened, the drainage plate including filter element are lifted due to the corresponding high spring force of the pressure spring. This considerably facilitates removal of the filter element from the receiving chamber. The filter element may thereby e.g. only slightly project from the receiving chamber and therefore be more easily removed.

With particular advantage, the drainage plate is disposed to be displaceable at least largely vertically with respect to the central longitudinal axis. The drainage plate is advantageously displaced parallel to the bottom which yields more safe insertion and closing of the drainage opening by the closing means. Jamming of the drainage plate on the pipe socket is moreover eliminated.

The drainage plate may thereby advantageously be designed like an annular ring disk having a central opening. As viewed from the top, it may have, in particular, a circular, oval or egg-shaped contour.

Braces for supporting on the bottom and/or on the filter element may also be provided on the drainage plate. This effects defined loading of the drainage plate by the filter element and also guidance of the motion of the drainage plate. Braces which are provided at the bottom may provide defined stops for the drainage plate.

In order to protect the housing material which may, in particular, be a plastic material, an intermediate plate or intermediate sleeve may be disposed at the bottom of the receiving chamber in order to support the pressure spring. The intermediate plate or intermediate sleeve may thereby be produced, in particular, from a metallic material.

In order to prevent inadvertent turning of the drainage plate about the central longitudinal axis of the receiving chamber, the drainage plate and/or pipe socket may have means for preventing rotation of the drainage plate. Such means may e.g. be guiding grooves or guiding braces on the drainage plate and/or on the pipe socket.

The pipe socket may, in particular, be designed as an impact pipe which is radially inwardly offset from the filter element and sealingly engages in an opening provided on the lower end side of the filter element. An impact pipe of this type prevents the receiving chamber from being completely emptied when the oil pressure drops.

In order to limit the motion play of the drainage plate in an axial upward direction, the pipe socket may have radially outwardly projecting projections. The projections advantageously extend at least slightly further in the radial direction than the central opening for the pipe socket provided on the drainage plate. Depending on the design and length of the pipe socket, the radially outwardly projecting projections may either be provided at the free end of the pipe socket or at a suitable location of the pipe socket.

Axially extending longitudinal groove sections may also be disposed on the pipe socket, wherein the drainage plate then comprises radially inwardly projecting projections that engage in the longitudinal grooves in order to limit the motion play of the drainage plate in an axially upward direction.

In accordance with the invention, the channel chamber may not only have the drainage opening of a drainage channel but also an unfiltered oil opening of an unfiltered oil channel, wherein the closing means engages into the channel chamber in the operating position such that the drainage opening is closed and the unfiltered oil opening is open. This embodiment is advantageous in that the unfiltered oil opening and the drainage opening terminate in the same channel chamber and only that channel chamber terminates in the receiving chamber.

Further details and advantageous embodiments of the invention can be extracted from the following description which illustrates and explains the invention in more detail with reference to the embodiment of the invention shown in the drawing.

### BRIEF DESCRIPTION OF THE DRAWING

FIG. 1 shows a longitudinal section through a first embodiment of an inventive oil filter assembly;

FIG. 2 shows a section along the line II of FIG. 1;

FIG. 3 shows an alternative embodiment of FIG. 2; and

FIG. 4 shows a longitudinal section through a second embodiment of the invention.

### DESCRIPTION OF THE PREFERRED EMBODIMENT

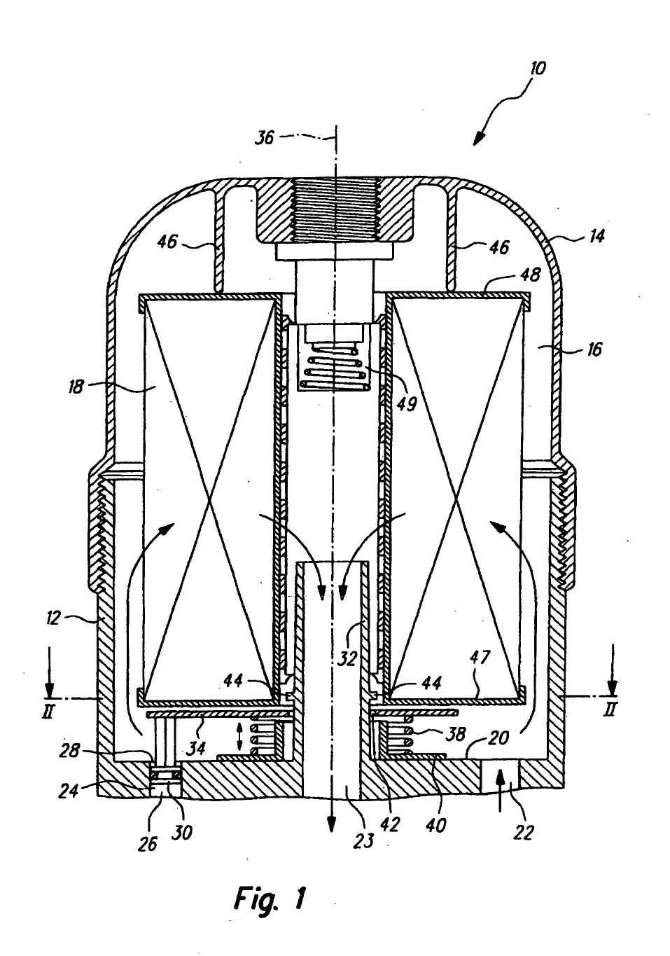

The oil filter assembly 10 shown in FIG. 1 has a housing 12 and a housing lid 14 which can be inserted, in particular, screwed onto the housing 12. The housing 12 has a receiving chamber 16 in which a filter element 18 is disposed through which a flow can pass in a radial direction from the outside to the inside.

An unfiltered oil opening 22 is provided at the bottom 20 of the receiving chamber 16 through which unfiltered oil flows into the receiving chamber 16. A channel chamber 26 designed as drainage channel 24 is moreover provided at the bottom 20, via which oil provided in the receiving chamber 16 can be discharged when the housing lid 14 is opened or when the filter element 18 is removed. The drainage channel 24 has a drainage opening 28. In the operating position of the filter assembly shown in FIG. 1 with closed housing and inserted filter element 18, the drainage opening 28 is closed by a closing means 30.

The closing means 30 itself is disposed on a drainage plate 34 which can be axially displaced in the bottom area of the receiving chamber 66 on a pipe socket 32. The drainage plate has a central opening 42, via which it is inserted onto the pipe socket 32. The drainage plate can thereby be displaced vertically with respect to the central longitudinal axis 36 of the filter assembly. The plug-like closing means 30 thereby engages in the drainage opening 28, wherein the drainage channel 26 extends in the area of the drainage opening 28 parallel to the central longitudinal axis 36. This ensures that the drainage channel 24 can be reliably closed, irrespective of the insertion depth of the closing means 30 into the drainage channel 24. The drainage plate 34 is pressed by a pressure spring 38 in an upward direction towards the housing lid 14. The pressure spring 38 is supported on the drainage plate 34 and also on an intermediate sleeve 40 provided at the bottom 20. The intermediate sleeve 40 is advantageously produced from a metallic material, wherein the housing 12 may be made from a plastic material.

Due to the spring loading of the drainage plate 34, the drainage plate is moved in an axial upward direction when the housing lid 14 is removed, whereby the closing means 30 releases the drainage opening 28, and the oil in the receiving chamber 16 can be discharged via the drainage channel 24. The pressure spring 38 is thereby advantageously designed such that the drainage plate 34 is lifted when the housing lid 14 is removed, and the filter element 18 is also moved in an axially upward direction. This facilitates removal of the filter element 18 from the receiving chamber 16.

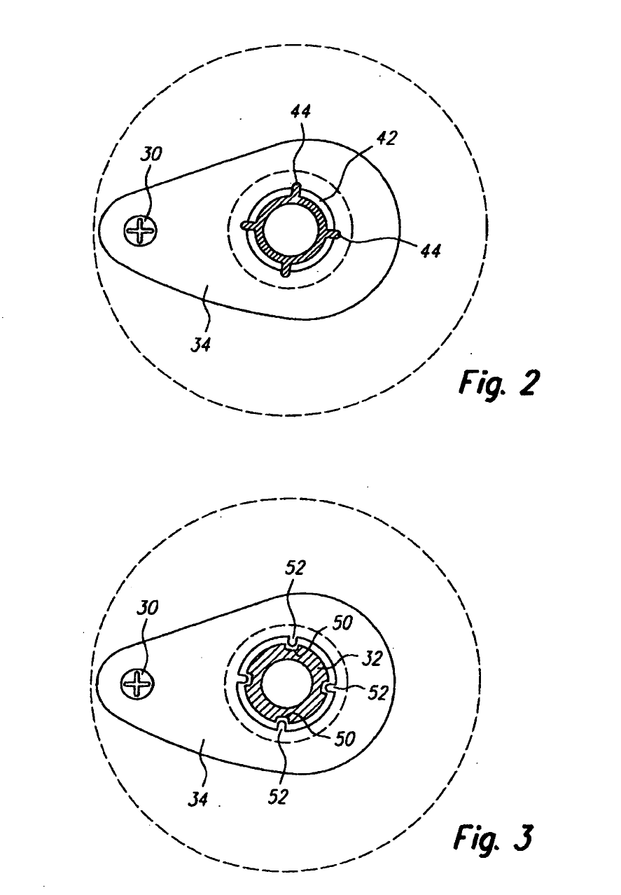

In order to arrange the drainage plate 34 on the pipe socket 32 in a non-detachable fashion, the pipe socket 32 has nose-like projections 44 that are directed in a radially outward direction. The projections 44 project at least slightly radially past the opening 42. This is also clearly shown, in particular, in FIG. 2. This prevents inadvertent release of the drainage plate 34 from the pipe socket 32 due to the spring force of the pressure spring 38.

In order to load the lower end side 47 of the filter element 18 against the spring force of the pressure spring 38 in the operating position, ribs 46 are provided on the lid 14, which engage the upper end side 48 of the filter element 18. A bypass valve 49 may be provided on the lid 14 or filter element 18 which opens in case of pressure increase due to a heavily soiled or blocked filter element.

FIG. 2 shows a section along line II of FIG. 1, illustrating a top view of only the drainage plate 34 as well as a cross-section through the pipe socket 32 with projections 44. One clearly sees that the projections 44 project radially past the central opening 42. The drainage plate has an egg-shaped contour in FIG. 2. In accordance with the invention, the drainage plate may also be oval or have a different shape.

FIG. 3 differs from FIG. 2 in that the pipe socket 32 has groove sections 50 that extend in an axial direction, into which projections 52 engage that are directed in a radial inward direction. Due to the limited length of the groove sections 50, the freedom of motion of the drainage plate 34 may be limited in an axial upward direction.

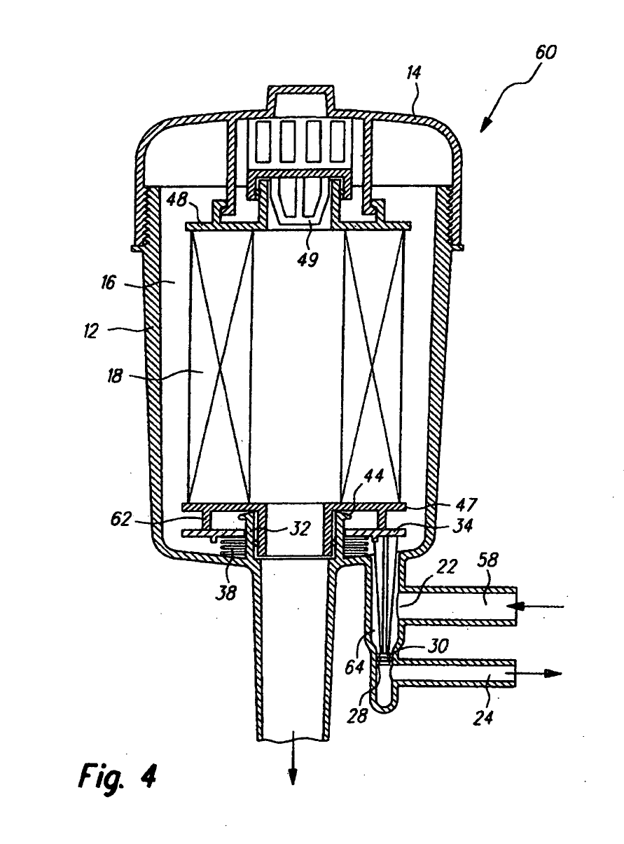

The components of the oil filter assembly 60 of FIG. 4, which correspond to those of the oil filter assembly 10, are labelled with corresponding reference numerals.

The oil filter assembly 60 differs from the oil filter assembly 10 in that a channel chamber 64 is provided into which both the unfiltered oil opening 22 of the unfiltered oil channel 58 and the drainage opening 28 of the drainage channel 24 terminate.

In the embodiment of FIG. 4, ribs 62 are provided on the lower end plate 47 of the filter element 18, which load the drainage plate 32 in a downward direction against the spring force of the pressure spring 38 supported on the housing bottom in the operating position shown in FIG. 4. The closing means 30 thereby closes the drainage opening 28 or the drainage channel 24. When the lid 14 is unscrewed, the axially movable drainage plate 32 with closing means 30 are moved in an axial upward direction via the pressure spring 38, thereby opening the drainage opening 30. The drainage plate 32 is thereby disposed on the pipe socket 32 such that it can be axially displaced. The pipe socket 32 has at its free end projections 44 that project in a radial outward direction and axially upwardly delimit the motion play of the drainage plate. In the area 90, the filter element 18 may be locked with ribs on the side of the lid or only be axially guided. The filter element is removed from the receiving chamber either together with the lid or without lid after the lid has been removed.

The drainage plate that can be displaced substantially vertically with respect to the central longitudinal axis is advantageous in that the closing means engages in the channel chamber 64 or the drainage opening 28 parallel to the central longitudinal axis. The drainage opening 28 must not be provided directly in the bottom area of the receiving chamber 16.

We claim:

1. An oil filter assembly comprising:
a housing having a receiving chamber, a housing lid that closes said receiving chamber, a pure oil or unfiltered oil opening surrounded by a pipe socket, and a channel chamber extending in a longitudinal direction of said receiving chamber, said pipe socket and said receiving chamber disposed at a bottom of said receiving chamber;
a filter element inserted into said housing and through which oil can flow in a radial direction;
a drainage plate disposed proximate to said bottom of said receiving chamber and having a central opening and a closing means, wherein said pipe socket engages in said central opening and said drainage plate is disposed at said pipe socket for axial displacement thereon; and
at least one pressure spring disposed between said drainage plate and said bottom, wherein, in an operating position when said housing is closed and said filter element is inserted, said drainage plate is loaded by said filter element in opposition to a spring force of said pressure spring, wherein said closing means closes a drainage opening of said channel chamber.

2. The oil filter assembly of claim 1, wherein, upon opening said housing lid, said drainage plate is pressed by said pressure spring out of said operating position into an outlet position in which said drainage opening is open.

3. The oil filter assembly of claim 2, wherein said pressure spring is designed such that said drainage plate and said filter element are lifted when said housing lid is opened.

4. The oil filter assembly of claim 1, wherein said drainage plate is disposed such that it can be displaced at least largely vertically with respect to a central longitudinal axis.

5. The oil filter assembly of claim 1, wherein said drainage plate is designed as an annular disc.

6. The oil filter assembly of claim 1, wherein said drainage plate has ribs for support on said bottom and/or on said filter element.

7. The oil filter assembly of claim 1, further comprising an intermediate plate or intermediate sleeve disposed at said bottom for supporting said pressure spring.

8. The oil filter assembly of claim 1, further comprising means disposed on said drainage plate and/or on said pipe socket for preventing rotation of said drainage plate about a central longitudinal axis.

9. The oil filter assembly of claim 1, wherein said pipe socket is designed as an impact tube and/or engages in an opening on said filter element.

10. The oil filter assembly of claim 1, wherein said pipe socket has projections that protrude in a radially outward direction to delimit a motion play of said drainage plate in an axially upward direction.

11. The oil filter assembly of claim 1, wherein said pipe socket has longitudinal grooves that extend in an axial direction and said drainage plate has projections which project in a radially inward direction to engage in said longitudinal grooves for delimiting a motion play of said drainage plate in an axialy upward direction.

12. The oil filter assembly of claim 1, wherein said channel chamber defines said drainage opening of said drainage channel as well as an unfiltered oil opening of an unfiltered oil channel and said closing means engages in said channel chamber in an operating position to close said drainage opening and to open said unfiltered oil opening.
